(19) United States
(12) Patent Application Publication
(10) Pub. No.: US 2010/0121958 A1
(43) Pub. Date: May 13, 2010

(54) INPUT-SENSITIVE INTERFACE SELECTION FOR POSTING

(75) Inventors: Uwe SCHWARZ, Veikkola (FI); Teemu Samuli HARJU, Sundsberg (FI); Timo Tapani ALAKOSKI, Helsinki (FI); Matti Ilmari VESTERINEN, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: NOKIA CORPORATION, Espoo (FI)

(21) Appl. No.: 12/267,292

(22) Filed: Nov. 7, 2008

(51) Int. Cl. G06F 15/16

(52) U.S. Cl. 709/228

(57) ABSTRACT

A system for supporting interactive functionality via the combined implementation of two or more messaging systems. This functionality may, in some instances, allow users/apparatuses to indirectly access remote resources that would not have ordinarily been available for direct access. Indirect access may be obtained, for example, by initially communicating utilizing a first messaging system and then employing a second messaging system when communication requirements exceed the abilities of the first system (e.g., where generating user content, such as posting information to the Internet, is difficult or impossible using the first system). While two different messaging systems are being employed, linkage between communication occurring in the first and the second messaging systems may be maintained through session information corresponding to the original interaction that took place via the first messaging system.

### BACKGROUND

1. Field of Invention

Various embodiments of the present invention relate wireless communication, and in particular, to integrating various messaging systems in order to provide required functionality.

2. Background

Support for wireless communication (e.g., apparatuses, resources, carrier range, etc.) continues to expand worldwide. This growth has not been limited only to users in nations considered to be economically wealthy and technologically advanced, but has also been evident in underdeveloped areas and in a user base having limited skills, resources, etc. In particular, the same interest in wireless services that, in addition to traditional voice functionality, may now provide Internet access, location and/or positioning, multimedia content, email, messaging and other types of wireless interaction to upper echelon users living in large metropolitan areas now also exists in lower class users, and in areas where wireless service has introduced a new ability to communicate where no widespread landline infrastructure was previously feasible due to, for example, the cost of implementation, terrain and technological obstacles, unskilled user base, etc.

Regardless of the desire for comprehensive wireless communication services for lower class users and in underdeveloped countries, the comprehensive wireless services that are now being offered in technologically developed regions remain unavailable. There are various reasons for this lack of support, including the lack of equipment required to provide more advanced wireless infrastructures, the lack of a consumer base needed to justify the substantial cost involved in obtaining such equipment, the lack of skill or user sophistication or skill needed to fully appreciate such functionality, etc. As a result, while a strong desire, and therefore a potential market, continues to exist for more advanced wireless communication functionality, the situation is problematic as such services are currently unavailable either on a regional basis, or even on a per-user basis, for people and places living under these less-fortunate circumstances.

### SUMMARY

Various embodiments of the present invention are directed to at least a method, apparatus, computer program product and system for supporting interactive functionality via the combined implementation of two or more messaging systems. This functionality may, in some instances, allow users/apparatuses to indirectly access remote resources that would not have ordinarily been available for direct access. Indirect access may be obtained, for example, by initially communicating utilizing a first messaging system and then employing a second messaging system when communication requirements exceed the abilities of the first system (e.g., where generating user content, such as posting information to the Internet, is difficult or impossible using the first system). While two different messaging systems are being employed, linkage between communication occurring in the first and the second messaging systems may be maintained through session information corresponding to the original interaction that took place via the first messaging system.

In accordance with at least one embodiment of the present invention that may be implemented on apparatuses utilizing the Global System for Mobile Communications (GSM), a first wireless messaging system supporting Unstructured Supplementary Service Data (USSD) functionality may be employed to initialize interaction. USSD is primarily an interactive tool, wherein alphanumeric information is used to send and receive messages that create, for example, user interface menus. As predominantly numerical input is expected when navigating in USSD, it is possible that some USSD handset interfaces may not easily facilitate substantial text (e.g., character) entry, and where this functionality is available, reconfiguring the interface to accept character input is often too technical for average users. These operational limitations can create configuration obstacles when using USSD for character input. Moreover, since USSD operates using a live connection, connection timeout errors may occur when a large amount of character input is required, for example, in situations where the posting of text message information on the Internet is facilitated by an intermediary agent (e.g., due to the lack of direct Internet access).

Further to the above example, another wireless messaging system (e.g., short message service (SMS)) may be utilized to fulfill the requirements of the wireless transaction that exceed the abilities of the first messaging system. In accordance with various embodiments of the present invention, activation of a secondary messaging system interface may be triggered when the requirements of the interaction exceed the abilities of the first system (e.g., character input is required in order to complete a transaction). Moreover, information pertaining to prior sessions occurring via the first messaging system may be passed to downstream recipients (e.g., via the second messaging system). In this manner, downstream entities (e.g., websites) that receive messages from the second messaging system may relate the content of these messages back to the activities that spawned the messages occurring via the first messaging system.

The above summarized configurations or operations of various embodiments of the present invention have been provided merely for the sake of explanation, and therefore, are not intended to be limiting. Moreover, inventive elements associated herein with a particular example embodiment of the present invention can be used interchangeably with other example embodiments depending, for example, on the manner in which an embodiment is implemented.

### DESCRIPTION OF DRAWINGS

Various embodiments of the present invention will be further understood from the following detailed description including example implementations and/or configurations of the various embodiments when taken in conjunction with appended drawings, in which:

FIG. 1 discloses an example of a computer and communication system with which the various embodiments of the present invention may be enabled or implemented.

FIG. 2 discloses an example scenario that will be utilized to explain the various embodiments of the present invention.

FIG. 3 discloses an example problem scenario and proposed solution that will be utilized to explain the various embodiments of the present invention.

FIG. 4 discloses an example system configuration in accordance with at least one embodiment of the present invention.

FIG. 5 discloses further detail regarding example system configuration of FIG. 4 in accordance with at least one embodiment of the present invention.

FIG. 6 discloses an example of the application of at least one embodiment of the present invention to a real world situation.

FIG. 7 discloses a flowchart of an example process in accordance with at least one embodiment of the present invention.

### DESCRIPTION OF EXAMPLE EMBODIMENTS

While the present invention has been described herein in terms of a multitude of example embodiments, various changes or alterations can be made therein without departing from the spirit and scope of the present invention, as set forth in the appended claims.

### I. General System with which Embodiments of the Present Invention May be Implemented

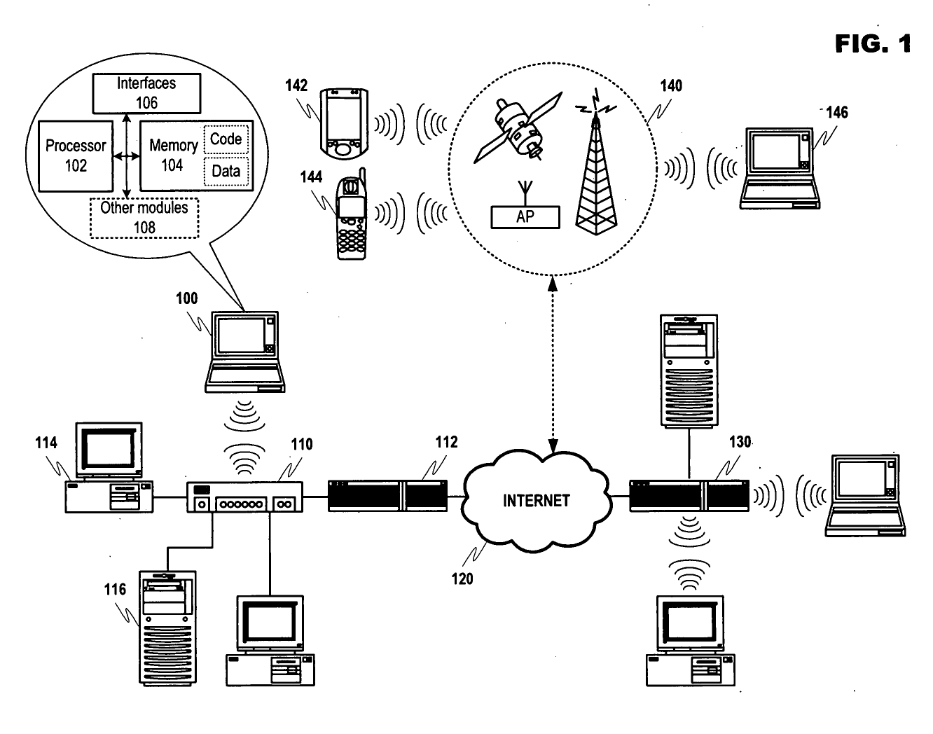

An example of a system that is usable for implementing the various embodiments of the present invention is disclosed in FIG. 1. This system comprises elements that may be included in, or omitted from, a configuration depending, for example, on the requirements of a particular application, and therefore, is not intended to limit present invention in any manner.

Computing device 100 may be, for example, a laptop computer. Elements that represent basic example components comprising functional elements in computing device 100 are disclosed at 102-108. Processor 102 may include one or more devices configured to execute instructions, wherein a group of instructions may be constituted, for example, as program code. In at least one scenario, the execution of program code may include receiving input information from other elements in computing device 100 in order to formulate an output (e.g., data, event, activity, etc). Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 100 may provide wired and/or wireless support to devices such as computer 114 and server 116. Hub 100 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

### II. Example Operational Scenario

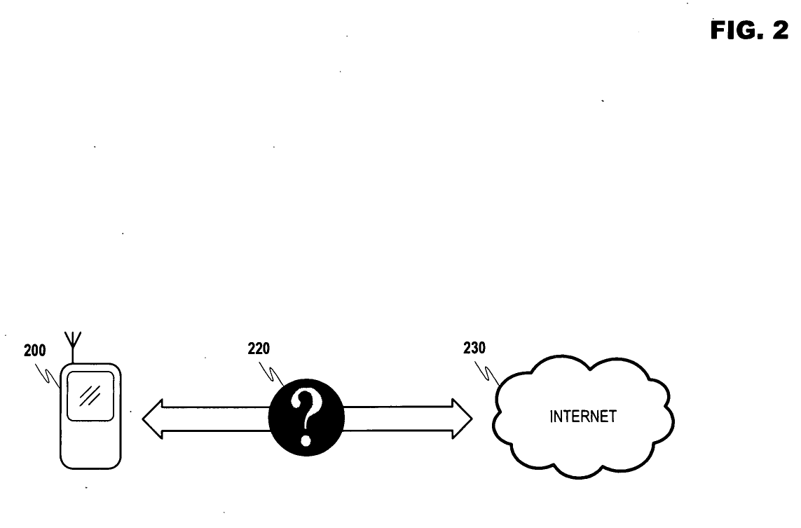

Now referring to FIG. 2, an example scenario is disclosed wherein an apparatus 200 desires to access the Internet 230, and the means by which the access is obtained is currently unknown (as shown at 220). This situation of FIG. 2 is presented merely as a basis by which the various embodiments of the present invention may be explained, and therefore, is not intended to limit application of said embodiments to the specific interaction that is disclosed. In view of the above, embodiments of the present invention may be implemented in various situations wherein the limitations of a wireless messaging system may present communication problems to a user.

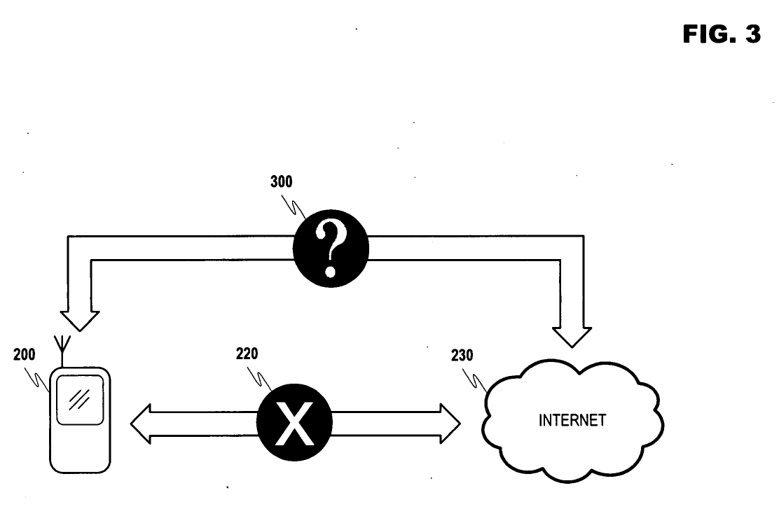

In FIG. 2 there is a question (as shown at 220) as to how apparatus 200 can access remote resources existing, for example, on the Internet. Ideally, at least one wireless medium supported by apparatus 200 would allow direct access to the desired resources. Direct access, for the sake of explanation herein, may constitute an interface on apparatus 200 allowing a user to directly access the desired resources in a transparent manner (e.g., without the user having to go through any substantial communication configuration). However, FIG. 3 presents a scenario where direct access 220 is not available. For example, the area in which apparatus 200 is being used may not have the wireless infrastructure to support a direct connection, direct access that is provided by the area is incompatible with apparatus 200, users of apparatus 200 do not have the knowledge or finances needed to obtain direct access, etc. One or more of these conditions may exist in more remote regions of the globe where only basic wireless communication resource can be established, or where an underdeveloped populace is unable to afford higher level services, and therefore, it would be hard for service providers to justify the installation and support costs.

In view of the above problems, FIG. 3 further asks whether access to the remote resources in Internet 230 may still be established at 300 using a configuration that acts indirectly. In particular, since no wireless communication means are available that will grant direct access to the desired resources on Internet 230, is there another configuration that may be implemented using the resources that are available that will allow a user to interact with the remote resources?

### III. Example Implementation

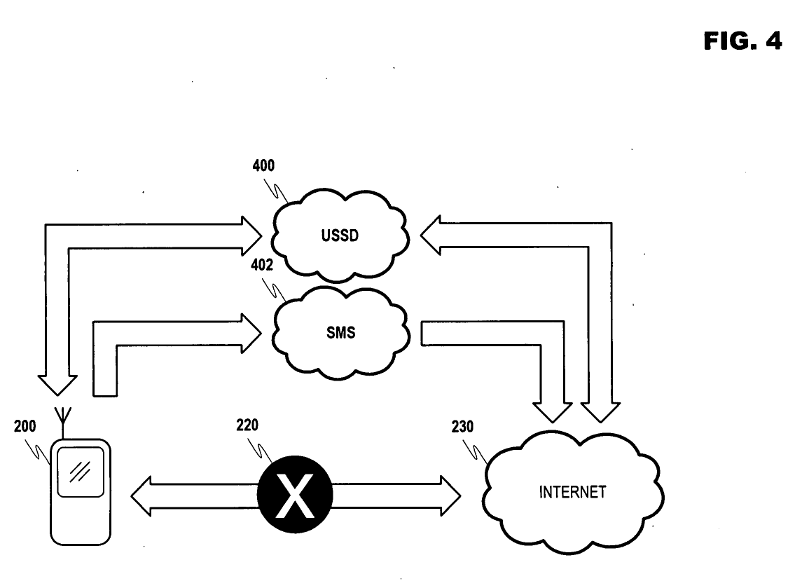

An example implementation, in accordance with at least one embodiment of the present invention, is disclosed in FIG. 4. In lieu of direct wireless access to remote resource, low overhead and/or complexity features that exists, for example, as part of the core specification for a wireless service may be employed in order to interact with remote resources in Internet 230. For example, the Global System for Mobile Communications (GSM) specification includes at least Unstructured Supplementary Service Data (USSD) 400 and short messaging service (SMS) 402 functionalities. These features may be implemented as part of baseline GSM support, and therefore, will often be available in areas where only basic cellular service is supported. In addition, the use of these data functionalities that are built into GSM remove the requirement for higher level communication apparatuses that are enabled to operate using specialized high speed and/or capacity data protocols, which allows a larger group of users (e.g., everyone with a basic GSM handset) to access more advanced data services. While GSM, and its related features, is used for the sake of explanation herein, various embodiments of the present invention are not limited to implementation in only GSM, and thus, may be applied in other wireless technologies.

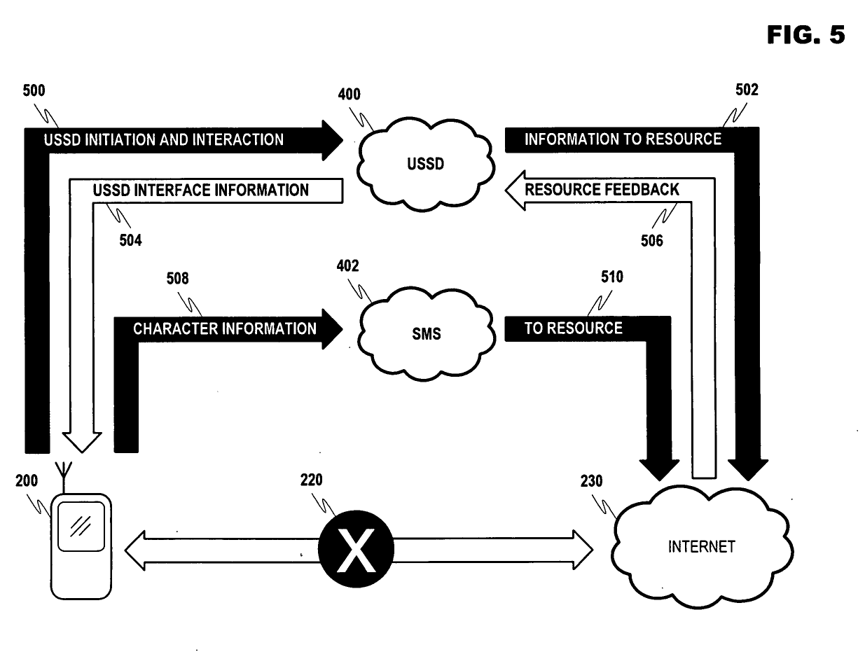

FIG. 5 discloses more detailed examples of indirect interaction between apparatus 200 and remote resources on Internet 230. For instance, a user may desire to post information on a website residing on Internet 230. However, this activity can be problematic with a wireless connection granting access to Internet 120 any desired resources residing thereon. In accordance with at least one embodiment of the present invention, USSD may be employed to initiate and interact with resources that can facilitate the desired posting as shown at 500. Unlike regular text messaging like SMS 400 wherein messages are composed and stored locally on an apparatus before being sent by a user, USSD 400 uses GSM signaling channels to query information and trigger services. No information is stored in the user apparatus. Users may initiate a service, for example, by inputting a certain dial code into a GSM handset. The apparatus may then receive a message presenting interface options related to the service. For example, message information may be used to display a service menu on apparatus 200. Users may then press numeric keys, based on the options displayed by the received message, and these numeric selections may trigger the sending and receiving of subsequent messages, desired functionality, etc.

FIG. 5 discloses an example interaction in accordance with the above. USSD activation and interaction 500 is represented as numeric commands being sent to an intermediary in USSD 400. This information may then be interpreted, and depending on the particular remote resource, information may be forwarded to the remote resource at 502. The remote resource may, in some instances, process the information and respond with feedback at 506, which may then be converted to USSD interface information at 504. In at least one scenario, apparatus 200 may utilize this information to formulate menus, instructions, prompts, etc. for display to a user.

A point may come during the USSD 400 interaction when character information (e.g., normumeric text) is required as part of the interaction with the remote resources on Internet 230. While it is possible to send characters via USSD 400, the configuration and execution of such a task is difficult and outside of the skill set of an average user. In such a situation, an SMS interface may be activated and utilized to send character information from apparatus 200 to SMS 402 as shown at 508. SMS 402 may then forward this information to resource 510. Multiple activities may occur as part of the SMS interface activation. In accordance with at least one embodiment of the present invention, USSD 400 may be discontinued. However, regardless of whether the USSD interaction continues or is closed, session information corresponding to the interaction occurring prior to SMS activation may be passed to SMS 402. The session information may be included in SMS messages sent from apparatus 200 so that entities receiving the message downstream from apparatus 200, for example the remote resources on Internet 230, may tie or relate the SMS message back to the USSD session that spawned its creation. The relationship identified by the session information may, for example, dictate how the remote resources on Internet 230 process the character information contained in the SMS message.

### IV. Application and Process Examples

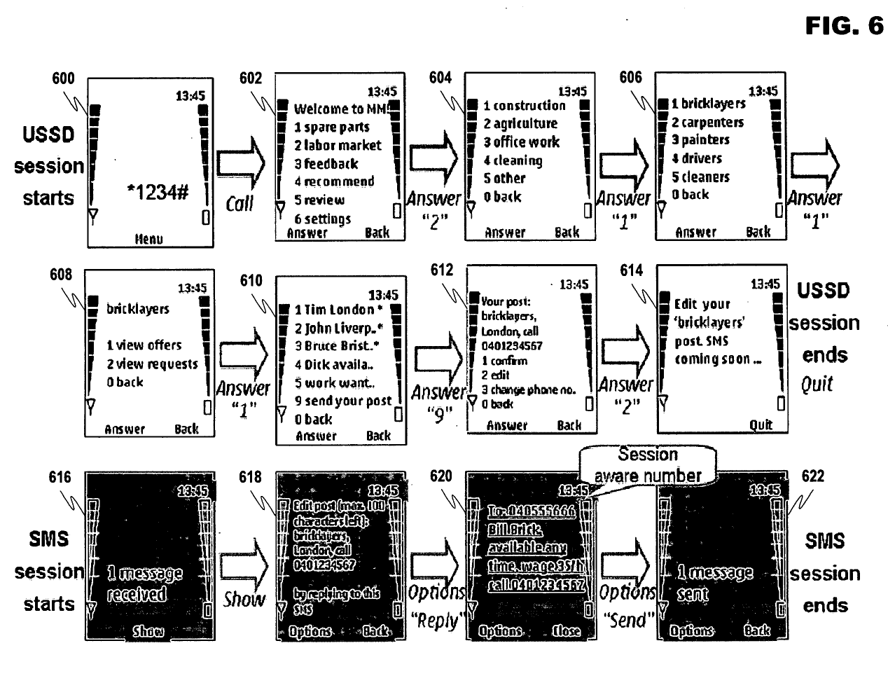

FIG. 6 discloses an example application of at least one embodiment of the present invention. Drawing reference numbers 600-622 represent what a user might see on the display of an apparatus (e.g., a cellular handset) when utilizing the disclosed embodiment. Further, the responses sent by the user are indicated between each display representation. USSD is activated in the disclosed example at 600 by entering a particular dial code. The particular USSD service that is accessed may then respond with selection information in the form of, for example, a menu (as shown at 602). The user may then select a number in accordance with each menu option from 602 until 612. Selecting numbers (e.g., “2” after 602) sends messages to the USSD service provider, to which the provider may respond with more information, such as shown at 604.

This process may continue from 606 to 614, wherein a user may traverse different menus by making numeric selections. However, in step 614 character information is required. The requirement for character information, in accordance with this particular example, may automatically trigger an SMS message to be sent to the user as shown at 616. 618-622 shows an example of user interaction with an SMS message. This interaction may include opening the received message, reviewing any instructions contained therein and responding in accordance with the instructions. The response sent at 622 may, in some instances, be conveyed to remote resources existing outside of the USSD service, for example, resources residing on Internet 230.

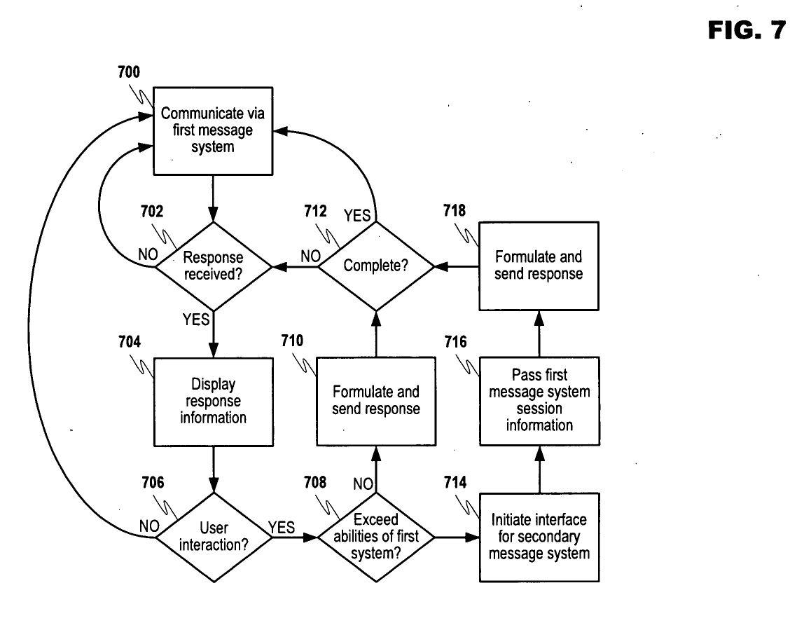

Now referring to FIG. 7, a flowchart of an example process in accordance with at least one embodiment of the present invention is now disclosed. In step 700 communication may initiate utilizing a first message system. This communication may include, for example, the activation of a service associated with the message system. The initial interaction may continue in step 700 until a response is received in step 702. Some or all of the information may then be displayed for a user in step 704. The information may be reformatted before display, for example, into a more user-friendly form such as in a listing, a menu, operating instructions, etc.

In step 706 a determination may be made as to whether user interaction is required (or desired) in response to the information displayed in step 704. If no interaction is required then the process may end and return to step 700 in order to await initiation of further communication. Alternatively, the process may proceed to step 708 wherein a determination may be made as to whether the required interaction is outside of the abilities of the first message system. If the interaction is within the scope of functionality granted by the first message system the process may proceed to step 710 where a user may formulate and send a response. The response in this scenario may be, for example a key press, the selection of a certain numeral as defined by a menu of options, a voice command, etc. If the process is complete after sending the response in step 710, then in step 712 a determination may be made to end the current session and restart at step 700. However, if at step 712 it is determined that the process is not complete, the process may return to step 702 to await a response to the message that was sent in step 710.

However, if in step 708 a determination is made that the required or desired user interaction will exceed the abilities of the first message system, then in step 714 an interface to a secondary message system may be initiated. Example interfaces may include applications that are initiated on the apparatus, messages received on the apparatus from the second messaging system, etc. Regardless of the disposition of the first message system session (e.g., activation of a second message system interface terminates the first message system session, etc.), session information from the first message system may be passed in step 716. Session information may comprise any type of data that allows downstream recipients to relate responses sent from the second message system back to the interaction that spawned it in the first message system.

The process may then proceed to step 718 for the formulation of a response message including at least the information requested, or required, as a result of the previous interaction via the first message system. The response message may then be transmitted via the second message system. In some configurations response messages may further include session information, previously passed by the first message system, for use by downstream devices when correlating response messages back to originating messaging session in the first message system. However, it is also possible for the session information to be conveyed to downstream recipients via other methods. For example, some or all of the session information may also be passed along as part of the mobile station international integrated services digital network number (MSISDN), on the network side (e.g., via the Internet), etc. In accordance with at least one embodiment of the present invention, two or more conveyance strategies may be employed simultaneously to transfer session information to various recipients. The process may then proceed to step 712 where a determination is made as to whether the process is complete, such as described above.

Accordingly, it will be apparent to persons skilled in the relevant art that various changes in form a and detail can be made therein without departing from the spirit and scope of the invention. The breadth and scope of the present invention should not be limited by any of the above-described example embodiments, but should be defined only in accordance with the following claims and their equivalents.

What is claimed:

1. A method, comprising:
establishing a communication session via a first messaging system;
communicating via the first messaging system;
if required by the communication, performing additional steps including:
activating a second messaging system;
passing at least session information from the first messaging system to the second messaging system; and
communicating via the second messaging system, wherein the communication is identified by at least the session information.

2. The method of claim 1, wherein the communication requirements result from user interaction with remote resources via the first messaging system.

3. The method of claim 1, wherein the communication requirements pertain to requirements for entering a type of information not supported by the first messaging system.

4. The method of claim 4, wherein the type of information is character information.

5. The method of claim 1, wherein the communication requirements comprise at least the posting user generated content to a network resource.

6. The method of claim 5, wherein a user menu selection in the first messaging system is used as at least part of the input for the user generated content.

7. The method of claim 1, wherein the first messaging system supports at least functionality for accessing remote resources via a menu-based alphanumeric interface and the second messaging system supports at least functionality for character-based message creation.

8. The method of claim 1, wherein communicating via the second message system comprises formulating at least one message, the message including at least one of character information and session information.

9. A computer program product comprising computer executable program code recorded on a computer readable medium, comprising:
computer program code configured to establish a communication session via a first messaging system;
computer program code configured to communicate via the first messaging system;
computer program code configured to, if required by the communication, perform additional steps including:
activate a second messaging system;
pass at least session information from the first messaging system to the second messaging system; and
communicate via the second messaging system, wherein the communication is identified by at least the session information.

10. The computer program product of claim 9, wherein the communication requirements result from user interaction with remote resources via the first messaging system.

11. The computer program product of claim 9, wherein the communication requirements pertain to requirements for entering a type of information not supported by the first messaging system.

12. The computer program product of claim 11, wherein the type of information is character information.

13. The computer program product of claim 9, wherein the first messaging system supports at least functionality for accessing remote resources via a menu-based alphanumeric interface and the second messaging system supports at least functionality for character-based message creation.

14. The computer program product of claim 9, wherein communicating via the second message system comprises formulating at least one message, the message including at least one of character information and session information.

15. An apparatus, comprising:
a processor, the processor being configured to:
establish a communication session via a first messaging system;
communicate via the first messaging system;
if required by the communication, perform additional steps including:
activate a second messaging system;
pass at least session information from the first messaging system to
the second messaging system; and
communicate via the second wireless messaging system, wherein
the communication is identified by at least the session information.

16. The apparatus of claim 15, wherein the communication requirements result from user interaction with remote resources via the first messaging system.

17. The apparatus of claim 15, wherein the communication requirements pertain to requirements for entering a type of information not supported by the first messaging system.

18. The apparatus of claim 17, wherein the type of information is character information.

19. The apparatus of claim 15, wherein the first messaging system supports at least functionality for accessing remote resources via a menu-based alphanumeric interface and the second messaging system supports at least functionality for character-based message creation.

20. The apparatus of claim 15, wherein communicating via the second message system comprises formulating at least one message, the message including at least one of character information and session information.

21. An apparatus, comprising:
means for establishing a communication session via a first messaging system;
means for communicating via the first messaging system;
means for, if required by the communication, performing additional steps including:
activating a second messaging system;
passing at least session information from the first messaging system to the second messaging system; and
communicating via the second messaging system, wherein the communication is identified by at least the session information.

22. A system, comprising:
an apparatus; and
a service;
the apparatus establishing a communication session with the service via a first messaging system and communicating with the service via the first messaging system;
the apparatus further, if required by the communication, performing additional steps including:
activating a second messaging system in the apparatus;
passing at least session information from the first messaging system to the second messaging system in the apparatus; and
communicating via the second messaging system with the service, wherein the communication is identified by at least the session information.
